(19) United States
(12) Patent Application Publication
(10) Pub. No.: US 2017/0106420 A1
(43) Pub. Date: Apr. 20, 2017

(54) METHOD AND APPARATUS FOR PRODUCING A COOLING LUBRICANT MIXTURE, FORMING PLANT FOR FORMING SEMI-FINISHED PRODUCTS AND USE OF A COOLING LUBRICANT MIXTURE

(71) Applicant: SMS GROUP GMBH, Düsseldorf (DE)

(72) Inventor: Klaus Reucker, Hilchenbach (DE)

(21) Appl. No.: 15/312,405

(22) PCT Filed: May 22, 2015
(86) PCT No.: PCT/EP2015/061389

§ 371 Date: Nov. 18, 2016

(30) Foreign Application Priority Data
May 26, 2014 (DE) 10 2014 210 037.2
Jun. 13, 2014 (DE) 10 2014 008 394.2
Oct. 15, 2014 (DE) 10 2014 220 940.4

(51) Int. Cl. B21B 45/02; B01F 15/06; B01F 3/08; F16N 39/04; B01F 3/20

(52) U.S. Cl. CPC B21B 45/02; F16N 39/04; B01F 3/2078; B01F 3/088; B01F 15/065; B01F 2015/062

(57) ABSTRACT

The invention relates to a method for producing a cooling lubricant mixture (2) for cooling and lubricating a working region (8) of a forming apparatus (5) for forming semi-finished products, in particular semi-finished products and forming tools, in which the cooling lubricant mixture (2) is mixed from at least two liquids (27, 29), and in which at least one of the liquids (27, 29) is preheated prior to the mixing with the other of the liquids (27, 29), wherein, for the preheating of the at least one of the liquids (27, 29), thermal energy (44) inherent to a used cooling lubricant mixture (2A) is at least partially transmitted to the at least one of the liquids (27, 29).

The invention relates on the one hand to a method for producing a cooling lubricant mixture for cooling and lubricating a working region of an apparatus for forming semi-finished products, in particular for cooling and lubricating semi-finished products and forming tools, in which the cooling lubricant mixture is mixed from at least two liquids and in which at least one of the liquids is preheated before the mixing with other liquid(s).

The invention relates and on the other hand to an apparatus for producing a cooling lubricant mixture, in particular an emulsion plant, for cooling and lubricating a working region of an apparatus for forming semi-finished products with a preparation container for preparing a cooling lubricant mixture ready for work, with a storage container for base oil, with a water storage container and with a catch container for the temporary collection of used cooling lubricant mixture.

Furthermore, the invention relates to a forming plant for forming semi-finished products, in particular a rolling mill, with an apparatus for forming the semi-finished products and with an apparatus for producing a cooling lubricant mixture.

The invention furthermore relates to the use of a cooling lubricant mixture.

In particular, a plurality of generic methods and apparatuses, especially also so-called emulsion plants, are known from the prior art and are used, for example, in forming plants for forming semi-finished products such as, for example, in rolling mills and in particular in cold rolling mills, aluminum hot rolling mills or the like in order to cool and at the same time lubricate the materials to be formed and the forming tools used to this end. Different emulsions are used for this which are rotated in a partially open circuit system and used as cooling lubricant mixtures. Such emulsions and cooling lubricant mixtures consist substantially of water and furthermore of a base oil in an amount of 1% to 10% of the emulsion, of emulsifiers, of stabilizers and of other additives. These emulsions meet a number of tasks.

On the one hand, in particular the base oil in the emulsion is deposited, for example, on material to be rolled and on the forming rollers in order to ensure good lubricating conditions in a roller slot and to build up a separating layer between the material to be rolled and the forming rollers.

On the other hand, in particular the water removes the heat being produced by the forming and/or rolling process and therefore prevents the danger of an overheating of the forming rollers and of roller structural components in general and the material to be rolled in particular.

Another task of the emulsion consists in removing contaminations which occur in particular in the working region and/or in the roller slot. These contaminations can be wear particles, dust particles from the environment and/or other particles but also hydraulic oils caused by leakages, storage lubricating oils and storage lubricating greases which can be brought into the emulsion by the circuit system which is open in the working region and/or in the associated structural region.

The previously known methods and apparatuses for producing and also for preparing cooling lubricant mixtures frequently form expensive mixtures which at times function rather ineffectively. Therefore, they bring about high costs in the manufacture, upkeep and in the maintenance.

The invention is based on the problem of further developing generic methods and apparatuses in such a manner that at least the previously cited disadvantages can be overcome.

The problem of the invention is solved by a method for producing a cooling lubricant mixture for cooling and lubricating a working region of an apparatus for forming semi-finished products, in particular for cooling and lubricating semi-finished products and forming tools, in which the cooling lubricant mixture is mixed from at least two liquids and in which at least one of the liquids is preheated before being mixed with the other liquid(s), wherein according to the invention a thermal energy present in a used cooling lubricant mixture is transferred at least partially to the at least one of the liquids for preheating the at least one of the liquids.

As a result of the fact that at least one of the liquids from which the cooling lubricant mixture, which is ready for work and ready to be used, is mixed is heated by the thermal energy of the already used cooling lubricant mixture, the method can be operated in a significantly more energy-efficient manner than was previously customary. Previously, the liquids for producing a cooling lubricant mixture were always heated with an additional heating apparatus. This is no longer required in the present case or at least is required to a greatly reduced extent.

To this extent, the making available of a cooling lubricant mixture can be carried out more advantageously in particular in a working region of a forming apparatus for forming semi-finished products.

The concept “cooling lubricant mixture” describes in the sense of the invention all emulsions which are used on a material-forming machine for cooling the material or semi-finished product or workpiece and for cooling appropriate forming tools. To this extent, the designation “cooling lubricant mixture” designates a precisely prepared mixture of emulsion-based oil and preferably of completely desalinated water.

In the sense of the invention a distinction is made between the cooling lubricant mixture which is ready for the working or for being used, the cooling lubricant mixture coming from the working region and therefore already used, and the cooling lubricant mixture which is used but which was made ready again, wherein the latter can be reused as the cooling lubricant mixture which is ready for working or for being used.

It is understood that very different cooling lubricant mixtures or emulsions can be used depending on the usage. In the example of a rolling mill, the cooling lubricant mixture is used, for example, as a rolling emulsion. Such cooling lubricant mixtures can be composed from various liquids and other constituents in order to become better adapted to the actual working conditions.

The cooling lubricant mixture mixed and used for a rolling process has, for example, an operating temperature of circa 50° C. This elevated operating temperature is required in order to on the one hand counteract dissociation processes and on the other hand to prevent or at least keep within limits the growth of algae and bacteria or the like. In the sense of the invention the concept “liquids” characterizes in particular different base oils and water, which are mixed with each other in order to produce appropriate cooling lubricant mixtures from them. However, other liquids required for a cooling lubricant mixture can also be advantageously preheated by the present method.

The concept “base oil” describes in this context one of the most important constituents or liquids from which the present cooling lubricant mixture is composed. The base oil is adjusted here for the material to be formed and furthermore also for the roller or structural type used, for example, in a rolling process.

As a rule, very well-refined and in particular paraffinic oils are used as base oil.

In order to achieve in particular a good solubility of this base oil with the water, it is advantageous if at least the base oil, but preferably the base oil and the water are preheated to an appropriately adjusted temperature, in particular before the base oil and the water are mixed with one another in a mixing process.

Since such cooling lubricant mixtures and base oils and other constituents are sufficiently known from the prior art, they will not be discussed further in the present case.

The circumlocution “a thermal energy present in the used cooling lubricant mixture” describes in the sense of the invention a cooling lubricant mixture which had already been used for cooling a working region of a forming apparatus and into which thermal energy conditioned by forming work and the like had been charged. Previously, this thermal energy charged into the used cooling lubricant mixture was not used for the preheating of in particular the base oil and the water, which are mixed with one another to produce the cooling lubricant mixture, but was usually discharged into the environment.

However, a preferred variant of the method provides that the cooling lubricant mixture is mixed from a base oil and water, wherein the part energy present in the used cooling lubricant mixture is transferred at least partially to the water and/or to the base oil, as a result of which the cooling lubricant mixture, which is ready for operation and contained in the preparation container, can be produced in particular with technical engineering and energetically.

In order that in particular the base oil can be mixed in an especially intimate manner with the water to the cooling lubricant mixture which is ready for operation, it is necessary that at least one of these liquids is heated to a temperature favorable for this. To this extent the problem of the invention is also solved by using a cooling lubricant mixture for heating a base oil and/or water for producing the cooling lubricant mixture. The cooling lubricant mixture can be produced in a more energetically favorable manner in that the cooling lubricant mixture coming from a working region of a forming apparatus and is therefore used and correspondingly heated by forming energy is used especially for preheating the base oil of the cooling lubricant mixture and/or water. Furthermore, it is advantageous if the thermal energy in the used cooling lubricant mixture is transferred at least partially to a cooling lubricant mixture which is stored in a preparation container and is ready for operation. This can further elevate the energy efficiency of the present method even more.

The plurality of methods can be advantageously increased if liquids for mixing the cooling lubricant mixture and/or the cooling lubricant mixture ready for operation itself are differently heated. For example, a major part of the thermal energy from the used cooling lubricant mixture can be transferred to the operationally ready cooling lubricant mixture. Or, most of the thermal energy in the used cooling lubricant mixture is transferred to the base oil so that the latter can dissolve especially well in the water.

If a transfer of the thermal energy in the used cooling lubricant mixture takes place after a workup of the used cooling lubricant mixture, the used cooling lubricant mixture can be worked up more warmly and optionally in a more advantageous manner. Or, the worked-up cooling lubricant mixture could be elevated to a higher thermal energy level, as a result of which additional thermal energy is available for being transferred to the base oil and/or to the water.

The energy balance of the present apparatus can be further improved if liquids for mixing the cooling lubricant mixture and/or the cooling lubricant mixture ready for operation itself is/are exclusively heated by the thermal energy present in the used cooling lubricant mixture.

The problem of the invention is solved by an apparatus for producing a cooling lubricant mixture, in particular from an emulsion plant, for cooling and lubricating a working region of a forming apparatus for forming semi-finished products with a preparation container for preparing the cooling lubricant mixture which is ready for operation, with the base oil storage container, with a water storage container and with a catch container for the temporary collecting of used cooling lubricant mixture, wherein the catch container is actively connected to the preparation container in such a manner that during the dwell time of the used cooling lubricant mixture flowing through the catch container the thermal energy in the used cooling lubricant mixture can be transferred at least partially to the operationally ready cooling lubricant mixture present in the preparation container. With such an apparatus the preparation of a cooling lubricant mixture can be undertaken in a more advantageous manner in particularly in the working region of a forming apparatus. This is especially advantageous in energy-intensive manufacturing plants such as, for example, forming plants and in particular rolling mills or the like.

In addition, the present apparatus or emulsion plant also has the problems of cleaning the used cooling lubricant mixture, adjusting the desired oil content in the operationally ready cooling lubricant mixture, adjusting and maintaining the desired operating temperatures as well as making available the required amounts of cooling lubricant mixtures for the rolling.

The problem is also solved by a forming plant for forming semi-finished products, in particular from a rolling mill, with a forming apparatus for forming the semi-finished products and with an apparatus for producing a cooling lubricant mixture, wherein the forming plant in general and the rolling mill in particular are distinguished by an apparatus for producing a cooling lubricant mixture according to one of the features described here.

If the forming plant and/or the rolling millare equipped with the present apparatus of the invention, the method of the invention can also be used in particular in this forming plant and in this rolling mill, as a result of which the forming plant and/or the rolling mill can be operated significantly more effectively.

Furthermore, it is clear as regards the present apparatus that the catch container can be constructed differently here, for example, as a collection apparatus for the temporary collection of the cooling lubricant mixture coming from the working region and therefore used, and/or only as a through passage apparatus to a preparation apparatus or the like for the used cooling lubricant mixture.

The thermal energy present in the used cooling lubrication mixture can be transferred with an especially simple construction in the sense of the invention if the catch container and the preparation container have a common separating wall through which the thermal energy present in the used cooling lubrication mixture is transferred to the operationally ready cooling lubrication mixture.

To this extent it is advantageous if the catch container and the preparation container commonly form a heat transmitter of the apparatus by means of which the thermal energy present in the used cooling lubrication mixture is transferred to the operationally ready cooling lubrication mixture.

In particular, the present method can be carried out with a very simple construction if the present apparatus is designed in such a manner that a cooling lubrication mixture line for conducting the used cooling lubrication mixture is cumulatively or alternatively in active contact with the base oil and/or with the water for mixing the cooling lubricant mixture.

At the same time the present apparatus advantageously comprises a preparation apparatus for filtering and cleaning the used cooling lubrication so that the used cooling lubrication mixture can be reused.

An especially advantageous embodiment also provides in this regard that the catch container and the preparation container are fluidically connected to one another by a cooling lubrication mixture line, wherein a preparation apparatus is fluidically integrated in the cooling lubrication mixture line, and wherein the cooling lubrication mixture line is actively connected to the base oil storage container and/or to the water storage container in such a manner that the thermal energy present in the used and/or the prepared cooling lubricant mixture is transferred at least partially to the base oil stored in the base oil storage container and/or to the water stored in the water storage container. In particular, the present method can be carried out in a very easy constructive manner as a result.

The thermal energy present in the used cooling lubricant mixture can be transferred to the base oil and to the water in a very easy constructive manner if the cooling lubricant mixture line is run through the base oil storage container and/or through the water storage container.

To this extent it is advantageous if the cooling lubricant mixture line and the base oil storage container and/or the water storage container form yet another heat transfer apparatus of the apparatus by means of which the thermal energy present in the used cooling lubricant mixture can be transferred to the base oil and/or to the water.

It is especially advantageous if the base oil storage container and/or the water storage container is/are fluidically arranged between the preparation apparatus and the preparation container, as a result of which the used cooling lubricant mixture can be available warmer and therefore also more viscous and furthermore the cooling lubricant mixture can be brought during the preparation procedure, if necessary, to a higher energy level before the thermal energy of the cooling lubricant mixture is transferred to the base oil and/or to the water.

Of course, a transfer of the thermal energy present in the used cooling lubricant mixture can take place before the preparation of the used cooling lubricant mixture, wherein in this case the base oil storage container and/or the water storage container is/are fluidically connected in front of the preparation apparatus.

It is advantageous, in particular at the beginning of a forming process, if the apparatus additionally comprises a heating and/or cooling apparatus for heating or cooling the operationally ready cooling lubricant mixture present in the preparation container, that is, at a time at which if possible there is not yet or no used cooling lubricant mixture available for the emission of heat.

It appears to be advantageous in this regard if the apparatus comprises another cooling lubricant mixture heating and/or cooling circuit by means of which the operationally ready cooling lubricant mixture present in the preparation container can be rotated through the heating and/or cooling apparatus.

Furthermore, it is also advantageous independently of the other features of the invention if the components of the apparatus are arranged in such a manner relative to each other that a waste thermal energy given off by the components of the apparatus can be transferred to the cooling lubricant mixture and/or to its components so that the cooling lubricant mixture and/or its components are heated. The apparatus and a forming plant can also be operated in a more efficient, energetic manner as a result.

For example, the individual containers for receiving heated liquids are directly adjacent to each other with their container walls so that a surface reduction in comparison to the environment can be achieved as regards the containers present.

In particular, the preparation container the catch container, the base oil storage container and/or the water storage container can be constructed as chambers with an active connection of a single, higher-order container apparatus so that a thermal energy can be made more intense in a cumulative or alternating manner.

Furthermore, this single container apparatus can optionally also comprise even other chambers for a process-control treatment of the cooling lubricant mixture, which also have an active connection with at least one of the other chambers.

Such a constellation is also advantageous without the other features of the invention.

As a result of the above-described features a flow of thermal energy can be conducted in a purposeful manner within the apparatus and can therefore be more effectively utilized.

If the apparatus additionally also comprises speed-regulated pumps for an as-needed delivery, the apparatus can be operated more effectively as regards energy. This avoids the situation that too many transported liquids have to flow off unnecessarily via overpressure valves or the like.

According to another aspect of the invention the present apparatus and/or emulsion plant are distinguished by an extremely space-saving construction.

In this connection it is advantageous if the apparatus has a container unit with at least two levels so that the components of the apparatus are arranged on at least two levels. As a result, the required structural space of the surface can be partially shifted into the otherwise unused level, which can save a not inconsiderable base surface since the features regarding this container unit are also advantageous without the other features of the present invention.

It is especially advantageous in this connection if the container unit is transport-ready and is optionally made ready on the working side with pre-mounted components of the apparatus.

The piping expense can be significantly reduced in an advantageous manner by the compact container unit, which achieves a reduction of the surface and consequently a heat loss to the environment can be reduced.

Moreover, this can reduce the transport paths of the liquid, as a result of which lower pressure losses can be achieved.

According to another aspect of the invention it is advantageous if the apparatus has a modular construction. As a result of such a modular construction the present apparatus can be at least partially and preferably entirely preassembled and tested during the production and delivered and mounted on appropriately provided connection apparatuses of the forming apparatus for forming the semi-finished products and can also be subsequently directly operated so that as a consequence the final assembly on-site can be significantly shortened, which achieves a correspondingly rapid startup. Therefore, the present apparatus can be assembled and constructed in particular according to the building block principal.

The modular construction of the apparatus can be realized in particular in conjunction with the container unit, which is to be compactly constructed. Another significant improvement of an apparatus for producing a cooling lubricant mixture can be achieved if the apparatus has a plurality of module places at which the components of the apparatus can be mounted with an exact fit. This alone can make it possible to advantageously further develop a generic apparatus so that this feature combination is advantageous already without the other features of the invention.

It should also mentioned at this point that the manufacturing costs can be reduced by about 20% in contrast to traditional apparatuses with the present apparatus.

Furthermore, up to 45% of electrical energy can be saved in comparison to the prior art with the present apparatus and the method of the invention.

Moreover, the present apparatus can also comprise cleaning apparatuses which can be constructed, for example, in the form of filters, magnetic separators, skimmers or the like, a plurality of supply tubes and return tubes and can comprise a rolling mill, agitator apparatuses and mixing apparatuses, pumps, valves, heating and cooling apparatuses and refilling apparatuses for base oil, water, etc.

Furthermore, the present invention can also be distinguished by the following aspects and features:

The container volumes of operating containers, base oil containers and water containers are optimized as concerns the particular consumption of theliquids and/or fluids in the case of operation and as concerns the avoidance of unnecessarily large storage volumes.

In the case of supplying an in particular five-platform tandem street with a required cooling lubricant means for a conti operation, the required operating container size is at first determined as a function of the requirements of the roller slot in order to do justice to the necessary requirements regarding a cleaning and a degassing of the cooling lubricant mixture.

The base oil used, for example, in a rolling process must be mixed back into the cooling lubricant mixture in the form of fresh base oil.

Therefore, in order to cover this requirement in a short time, the present invention is provided with the base oil storage container for receiving, tempering and storing the base oil.

The volume of this base oil storage container is preferably optimized as regards the consumption to be expected which ensures, based on values derived from experience, a reliable continuous operation without interruptions for a time of approximately 220 to 450 operating hours without a refilling.

In order to ensure an optimal and thorough mixing and for the adding of the used base oil, the latter is injected in precisely dosed amounts during the operation of the apparatus, for example, in suction lines of initial pumps.

The vortices and shearings produced by the pumping procedure ensure an optimal and continuous mixing of the components and of the constituents of the cooling lubricant mixture.

In order to avoid disturbances of the rolling process by excessive lubrication and in order to reduce the specific consumption of base oil, the addition preferably takes place by an appropriately suitable dosing pump.

The preferably totally desalinated water used in the rolling process must be mixed back into the cooling lubricant mixture in the form of fresh water.

In order to cover this requirement in a short time, the present apparatus is provided with the water storage container for receiving, tempering and storing the water.

The volume of this water storage container is ideally optimized to the expected consumption, which ensures a reliable continuous operation without interruptions, also based on experienced values.

An intermittent refilling from a present working network is possible based on the required volume to be added of on the average approximately 5 m³ per hour.

An existing storage volume of 30 m³ is sufficient for a short-time freshening of the cooling lubricant mixture, for example by replacing a partial amount.

In order to ensure an optimal thorough mixing and for adding the used, preferably totally desalinated water, the latter is mixed in in a precisely measured amount during the operation through a suction line of an appropriately designed filter pump.

The vortices and shearings produced by the pumping process also ensure an optimal and continuous mixing of the components here.

In order to avoid disturbances of the rolling process due to a lack of lubrication and in order to reduce the specific consumption of preferably totally desalinated water the addition takes place in a volume-controlled manner and preferably in small amounts.

The present invention can furthermore be characterized in that the care and preparation of the cooling lubricant mixture and/or of the emulsion is optimized in the actual operating container by a special flow guidance.

The amounts of the cooling lubricant mixture and of the emulsion transported in the rolling process vary constantly between 0 and 100%.

These variations must be processed in particular by the preparation container and its downstream regeneration apparatuses such as, for example, magnetic separators, vacuum filters, heaters, coolers, a skimming apparatus or the like in order to ensure the cleaning, tempering, distribution of drop size, separation of foreign oil, etc. in accordance with the requirements.

The cooling lubricant mixture which was adversely affected by the rolling process and is therefore used passes either through a return pumping station or directly through a return line into a catch container or into a contamination chamber of the preparation container.

This catch container and/or this contamination chamber, the size of which is preferably approximately 15% of the preparation container, preferably consist(s) only of the common separating wall and/or of an appropriately constructed separating sheet which project(s) up to a filling height of approximately 60% of the preparation container inside the preparation container.

A scooping-off unit or a skimming-off unit can also be installed above this catch container.

The cooling lubricant mixture or the emulsion can be removed by suction from this catch container and supplied to the magnetic separators of the magnetic separator unit.

In order to optimize an iron separation rate, the flowthrough of the magnetic separator is continuous and amounts to approximately 110% of the cooling lubrication mixture amount or emulsion amount transported by the rolling process.

A vacuum filter can also be subsequently connected in which is supplied from the magnetic separators in accordance with the requirements for the cleanliness of the cooling lubricant mixture and/or of the emulsion.

After having passed these cleaning stages, the cooling lubricant mixture passes into the actual clean chamber of the preparation container.

The preparation container is accordingly preferably subdivided into a contamination chamber for receiving the used cooling lubricant mixture and into a clean chamber for receiving the cooling lubricant mixture ready for operation. The contamination chamber and the clean chamber are spatially separated from each other only by the common separating wall.

In order to achieve a homogeneous distribution, a distributor pipe is ideally used.

In order to adjust the operating temperature the cooling lubricant mixture ready for operation is removed from the distributor pipe by suction and adjusted to the required temperature by appropriate heating apparatuses or cooling apparatuses.

Since only a partial current of the cooling lubricant mixture returning from the rolling process is tempered, an exact control of the temperature and a distribution and mixing of the treated cooling lubricant mixture in the preparation is of great importance.

The necessary degassing and separation of foreign oil can be achieved with a simple construction by a subsequent, calmed flowthrough of the preparation.

If the flow rate in this area of the preparation container is to be abnormally reduced, the mixing of the operationally ready cooling lubricant mixture can preferably be maintained by agitators or the like.

In particular, the foreign oil to be separated can settle on the surface of the bath in particular based on the flow conditions purposefully adjusted in the preparation container by an appropriate balancing of the amount and can flow to the contamination chamber where it is scooped off by an appropriately designed skimmer apparatus.

The optimal engineering treatment of the cooling lubricant mixture can be ensured especially at a filling degree of 75% of the preparation container.

The cooling lubricant mixture can preferably be removed by suction with centrifugal pumps opposite the contamination chamber, that is, preferably on the other end of the preparation chamber, and be supplied with the proper pressure adjustment back to the rolling process.

The balancing of the circulating amounts of the cooling lubricant mixture can be formulated as follows:
Requirement of the rolling process for the amount of the cooling lubricant mixture: 0-100% variable,
Amount of the cooling lubricant mixture flowing back from the rolling process into the container: 0-100% variable,
Amount of the cooling lubricant mixture supplied to the magnetic separator from the contamination chamber: 110% constant,
Amount of the cooling lubricant mixture supplied to the vacuum filter from the magnetic separator: 110% constant,
Amount of the cooling lubricant mixture passing from the filter apparatuses into the clean chamber: 110% constant,
Amount of the cooling lubricant mixture returned to the rolling process: 0-100% variable.

It is understood that the features of the present solutions and of those described in the claims can optionally also be combined in order to be able to convert them into advantages in an appropriately cumulative manner.

Other features, effects and advantages of the present invention are explained using the attached drawings and the following description in which an apparatus for producing and preparing a cooling lubricant mixture for a forming apparatus in a forming plant is shown and described by way of example.

In the drawings:

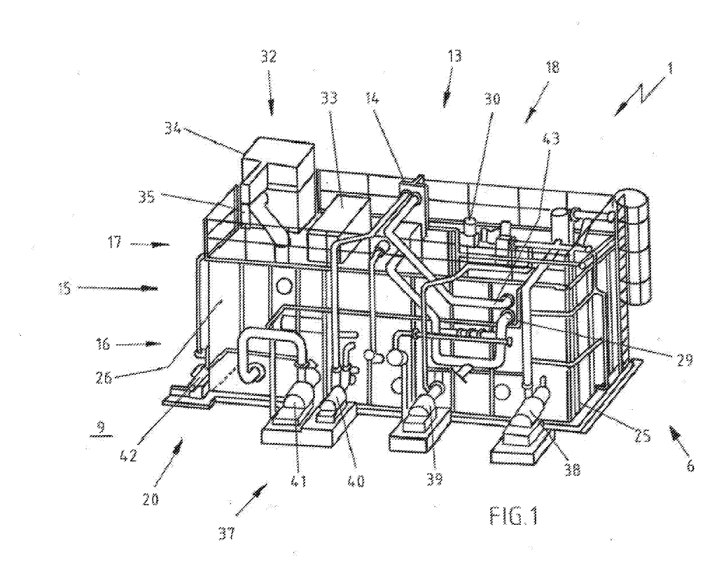

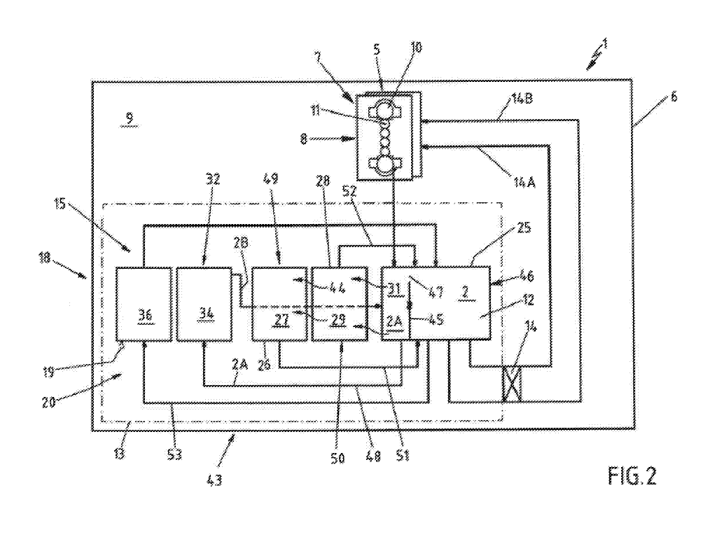

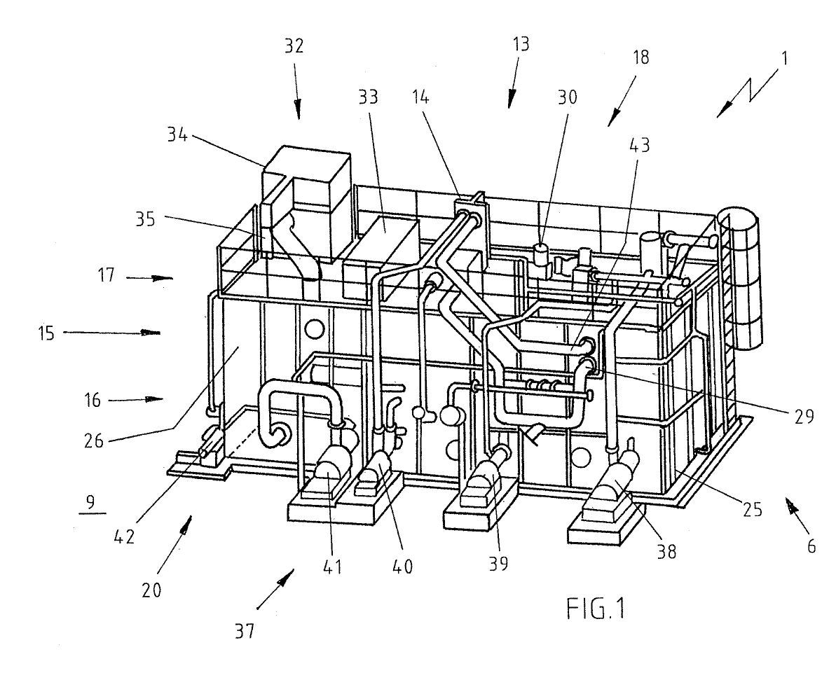

FIG. 1 schematically shows a perspective view of a two-level and modularly constructed apparatus for producing and preparing a cooling lubricant mixture; and

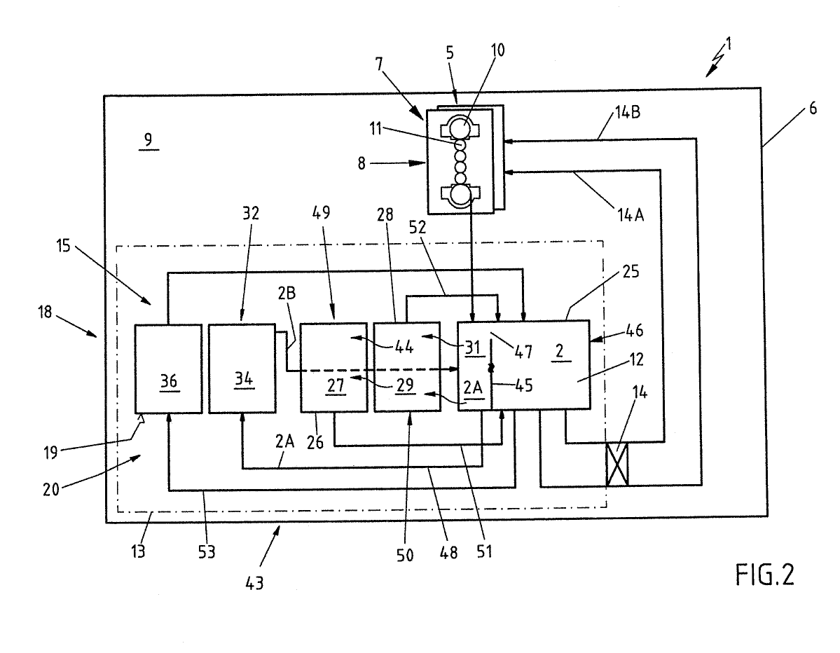

FIG. 2 schematically slows a fluid circuit diagram of the apparatus shown in FIG. 1.

The cooling lubricant mixture 2 that is operationally ready for a forming apparatus 5 (see FIG. 2) of a forming plant 6 is mixed with the apparatus 1 schematically shown in FIGS. 1 and 2 for producing and preparing an operationally ready cooling lubricant mixture 2 (see FIG. 2).

The forming apparatus 5 comprises forming tools 7 with which a workpiece and/or a semi-finished product (not shown) can be formed in an appropriate working region 8. More precisely, the material from which the workpiece and/or the semi-finished product consist(s) is worked and therefore formed in the working region 8 of the forming apparatus 5.

The forming plant 6, which is supplied with the cooling lubricant mixture 2 with the aid of the present apparatus 1, is in particular a rolling mill 9; accordingly, the forming apparatus 5 is a rolling apparatus 10 for rolling in particular a material strip or material band (not shown). To this end the forming apparatus 5 or the rolling apparatus 10 comprises in is working region 8 a plurality of rollers 11 (numbered only by way of example) which interact with the material strip or the material band.

In this embodiment the cooling lubricant mixture 2 is a rolling emulsion 12 by means of which on the one hand the semi-finished product and the rollers 11 interacting with it in the working region 8 are lubricated and on the other hand in particular the rollers 11 are cooled. To this extent the apparatus 1 showing here is especially designed as an emulsion plant 13.

The forming apparatus 5 and/or the rolling apparatus 10 is fluidically connected to a connection apparatus 14 of the apparatus 1, wherein a roller cooling line 14A and a roller lubricating line 14B run from this connection apparatus 14 to the forming apparatus 5 and/or to the rolling apparatus 10.

The apparatus 1 showing here is distinguished in particular by a modularly constructed container unit 15 which comprises two levels 16 and 17 at least in this exemplary embodiment on which the very different components 18 of the apparatus 1 are arranged in a distributed manner.

The modularly constructed container unit 15 makes a plurality of modular places 19 available which are designed in such a manner that each of the components 18 can be mounted with an exact fit on the particularly provided modular place 19. To this extent the apparatus 1 can be assembled significantly more rapidly.

Due to its modular construction 20, a rapid and error-free assembly of the individual components 18 to each other can take place even by untrained personnel.

The apparatus 1 is distinguished in particular by a preparation container 25 for making the operationally ready cooling lubricant mixture 2 available by a base oil storage container 26 for storing base oil 27 and by a water storage container 28 for storing water 29, wherein the operationally ready cooling lubricant mixture 2 is produced in particular by a mixing of the base oil 27 with the water 29 in an agitating and/or mixing apparatus 30.

In addition, the apparatus 1 also comprises a catch container 31 for the temporary collecting and furthering of used cooling lubricant mixture 2A returning from the working region 8.

Furthermore, the apparatus 1 also comprises a preparation apparatus 32 for preparing and filtering and cleaning the cooling lubricant mixture 2A returning from the working region 8, wherein the preparation apparatus 32 comprises in particular a scooping unit 33, a magnetic separating unit 34 and a magnetic separating tank 35.

Moreover, the apparatus 1 also comprises a heating and/or cooling apparatus 36 for heating and/or cooling the operationally ready cooling lubricant mixture 2 present in the preparation container 25.

In addition to the container unit 15, a few auxiliary units 37 are also placed at the level of the lower level 16, of which two delivery pumps 38 and 39 for delivering the operationally ready cooling lubrication mixture 2, a heating apparatus pump 40, a filter pump 41 and a basal pump 42 can be seen by way of example.

It is understood that in particular the previously cited components 18 of the apparatus 1 are fluidically connected to each other by an appropriately placed piping 43, wherein this piping 43 is also very compactly constructed on account of the two-level container unit 15 which is therefore extremely compactly constructed.

An especially energy-effective method for producing the cooling lubricant mixture 2 for cooling and lubricating the working region 8 of the forming apparatus 5 can be carried out with the apparatus 1 constructed in this manner, in which the operationally ready cooling lubricant mixture 2 is mixed from at least two liquids, namely, the base oil 27 and the water 29, and in which at least one of the liquids is preheated prior to the mixing with the other one of the liquids, wherein in order to preheat the at least one of the liquids a thermal energy 44 (indicated and designated only by way of example, see FIG. 2) present in the used cooling lubricant mixture 2 is transferred at least partially to the at least one of the liquids.

In the present exemplary embodiment the thermal energy 44 present in the used cooling lubricant mixture 2A is transferred to the base oil 27 and to the water 29 in such a manner that further heating units for heating the base oil 27 and the water 29 can dispensed with.

Furthermore, the apparatus 1 and the arrangement of the storage container 25 and of the catch container 31 are arranged in such a manner that the thermal energy 44 present in the used cooling lubricant mixture 2A is transferred at least partially to the operationally ready cooling lubricant mixture 2 stored in the preparation container 25.

As can be readily recognized from the view according to FIG. 2, the catch container 31 and the preparation container 25 comprise to this end a common separating wall 45 through which the thermal energy 44 present in the used cooling lubricant mixture 2A is transferred to the operationally ready cooling lubricant mixture 2, so that the catch container 31 and the preparation container 25 together form a heat transmitter 46 with which the thermal energy 44 present in the used cooling lubricant mixture 2A can be transferred to the operationally ready cooling lubricant mixture 2.

Furthermore, even the base oil storage container 26 and the water storage container 28 are arranged in such a manner that relative to one another and to the catch container 31, but also to the preparation container 25 that the thermal energy 44 present in the used cooling lubricant mixture 2A can be transferred to the base oil 27 stored in the base oil storage container 26 and to the water stored in the water storage container 28. In addition to an overflow 47, the catch container 31 and the preparation container 25 are also fluidically connected to one another by a cooling lubricant mixture line 48, wherein the preparation apparatus 32 is fluidically integrated in this cooling lubricant mixture line 48.

The cooling lubricant mixture line 48 is actively connected to the base oil storage container 26 and to the water storage container 28 in such a manner that the thermal energy 44 present in the used cooling lubricant mixture 2A and in a prepared cooling lubricant mixture 2B can be transferred at least partially to the base oil 27 stored in the base oil storage container 26 and to the water 29 stored in the water storage container 28.

Therefore, in the present case a first section of the cooling lubricant mixture line 48 together with the base oil storage container 26 forms another thermal transmitter 49 of the apparatus 1 and another section of the cooling lubricant mixture line 48 together with the water storage container 28 forms yet another thermal transmitter 50 of the apparatus 1.

The base oil 27 preheated in this manner can be supplied to the agitating and/or mixing apparatus 30 and to the preparation container 25 by a base oil line 51, whereas the preheated water 29 is supplied to the agitating a mixing apparatus 30 and/or to the preparation container 25 by a water line 52.

The heating apparatus 36 is integrated in a heating-cooling circuit 53 for the cooling lubricant mixture in which the operationally ready cooling lubricant mixture 2 is rotated if it should be necessary to additionally heat or cool the latter.

If it is not necessary to heat the cooling lubricant mixture 2 stored in the preparation container 25 by the thermal energy present in the used cooling lubricant mixture 2A, the used cooling lubricant mixture 2A can be conducted past it, for example, via a bypass, which is not shown here, on the catch container 31, so that the thermal energy present in the cooling lubricant mixture 2A can be available substantially entirely to the base oil storage container 26 and/or to the water storage container 28.

It is explicitly pointed out at this point that the features of the previous solutions and of those described in the claims can optionally also be optionally combined in order to be able to convert them into effects and advantages in an appropriately cumulative manner.

It is understood that the previously explained exemplary embodiment is only a first embodiment of the apparatus of the invention for producing and preparing cooling lubricant mixtures. To this extend the design of the invention is not limited to this exemplary embodiment.

All features disclosed in the application documents are claimed as essential for the invention in as far as they are novel individually or in combination over the prior art.

### LIST OF REFERENCE NUMERALS

1 apparatus
2 cooling lubricant mixture
2A used cooling lubricant mixture
2B used and prepared cooling lubricant mixture
5 forming apparatus
6 forming plant
7 forming tools
8 working region
9 rolling mill
10 rolling apparatus
11 rollers
12 roller emulsion
13 emulsion plant
14 connection apparatus
14A roller cooling line
14B roller lubrication line
15 container unit
16 bottom layer
17 upper layer
18 components
19 module places
20 modular construction
25 preparation container
26 base oil storage container
27 base oil
28 water storage container
29 water
30 agitating and/or mixing apparatus
31 catch container
32 preparation apparatus
33 scooping unit
34 magnetic separating unit
35 magnetic separating tank
36 heating and/or cooling apparatus
37 auxiliary units
38 first delivery pump
39 second delivery pump
40 heating apparatus pump
41 filter pump
42 base oil pump
43 piping
44 thermal energy
45 common separating wall
46 heat transmitter
47 overflow
48 cooling lubrication mixture line
49 other heat transmitter
50 another heat transmitter
51 base oil line
52 water line
53 heating and/or cooling circuit for the cooling lubrication mixture

1. A method for producing a cooling lubricant mixture (2) for cooling and lubricating a working region (8) of a forming apparatus (5) for forming semi-finished products, in particular for cooling and lubricating semi-finished products and forming tools, in which the cooling lubricant mixture (2) is mixed from at least two liquids (27, 29) and in which at least one of the liquids (27, 29) is preheated before the mixing with other one of the liquids (27, 29), characterized in that before mixing the at least two liquids (27, 29), a thermal energy (44) present in a used cooling lubricant mixture (2A) is transferred at least partially to the at least one of the liquids (27, 29) for preheating the at least one of the liquids (27, 29).

2. The method according to claim 1, characterized in that the cooling lubricant mixture (2) is mixed from a base oil (27) and water (29), wherein the thermal energy (44) present in the used cooling lubricant mixture (2A) is transferred at least partially to the water (29) and/or to the base oil (27).

3. The method according to claim 1, characterized in that the thermal energy (44) present in the used cooling lubricant mixture (2A) is transferred at least partially to an operationally ready cooling lubricant mixture (2) stored in a preparation container (25).

4. The method according to claim 1, characterized in that liquids (27, 29) for mixing the operationally ready cooling lubricant mixture (2) and/or the operationally ready cooling lubricant mixture itself (2) are differently heated.

5. The method according to claim 1, characterized in that a transfer of the thermal energy (44) in the used cooling lubricant mixture (2A) takes place after a workup of the used cooling lubricant mixture (2A).

6. The method according to claim 1, characterized in that liquids (27, 29) for mixing the operationally ready cooling lubricant mixture (2) and/or the operationally ready cooling lubricant mixture itself (2) are exclusively heated by the thermal energy (44) present in the used cooling lubricant mixture (2A).

7. An apparatus (1) for producing a cooling lubricant mixture (2), in particular an emulsion plant (12), for cooling and lubricating a working region (8) of a forming apparatus (10) for forming semi-finished products with a preparation container (25) for preparing operationally ready cooling lubricant mixture (2), with a base oil storage container (26), with a water storage container (28) and with a catch container (31) for the temporary collecting of used cooling lubricant mixture (2A), wherein the catch container (31) is actively connected to the preparation container (25) in such a manner that during the dwell time of the used cooling lubricant mixture (2A) flowing through the catch container (31) the thermal energy (44) in the used cooling lubricant mixture (2A) can be transferred at least partially to the operationally ready cooling lubricant mixture (2) present in the preparation container (25) characterized in that the catch container (31) and the base oil storage container (26) and/or the water storage container (28) are arranged in such a manner that to each other that the thermal energy (44) present in the used cooling lubricant mixture (2A) can be transferred to the base oil (27) stored in the base oil storage container (26) and/or to the water (29) stored in the water storage container (28).

8-10. (canceled)

11. The apparatus (1) according to claim 7, characterized in that the catch container (31) and the preparation container (25) are fluidically connected to one another by means of a cooling lubrication mixture line (48), wherein a preparation apparatus (32) is fluidically integrated in this cooling lubrication mixture line (48), and wherein this cooling lubrication mixture line (48) is actively connected to the base oil storage container (26) and/or to the water storage container (28) in such a manner that the thermal energy (44) present in the used and/or the prepared cooling lubricant mixture 2A; 2B) can be transferred at least partially to the base oil (27) stored in the base oil storage container (26) and/or to the water (29) stored in the water storage container (28).

12. The apparatus (1) according to claim 11, characterized in that the cooling lubricant mixture line (48) is run through a base oil storage container (26) and/or the water storage container (28).

13. The apparatus (1) according to claim 11, characterized in that the cooling lubricant mixture line (48) and the base oil storage container (26) and/or water storage container (28) form at least one other heat transmitter (49, 50) of the apparatus (1) by means of which the thermal energy (44) present in the used cooling lubricant mixture (2A) can be transferred at least partially to the base oil (27) and/or to the water (29).

14. The apparatus (1) according to claim 7, characterized in that the base oil storage container (26) and/or the water storage container (28) is/are fluidically arranged between the preparation apparatus (32) and the preparation container (25).

15. The apparatus (1) according to claim 7, characterized in that the apparatus (1) comprises a heating and/or cooling apparatus (36) for heating or cooling the operationally ready cooling lubricant mixture (2) present in the preparation container (25).

16. The apparatus according to claim 15, characterized in that the apparatus (1) comprises another cooling lubricant mixture heating and/or cooling circuit (53) by means of which the operationally ready cooling lubricant mixture (2) present in the preparation container (25) can be rotated through the heating and/or cooling apparatus (36).

17. The apparatus (1) according to claim 7 characterized in that the components (18) of the apparatus (1) are arranged in such a manner relative to each other that a waste thermal energy given off by the components (18) of the apparatus (1)) can be transferred to the cooling lubricant mixture (2) and/or to its components (27, 29) so that the cooling lubricant mixture (2) and/or its components (27, 29) are heated as a result.

18. The apparatus (1) according to claim 7 characterized in that the preparation container (25), the catch container (31), the base oil storage container (26) and/or the water storage container (28) can be constructed as chambers with an active connection of a single, higher-order container apparatus so that a thermal energy (44) can be made more intense in a cumulative or alternating manner.

19. The apparatus (1) according to claim 7 characterized in that the apparatus (1) comprises speed-regulated pumps (38, 39, 40, 41, 42) for delivery as needed.

20. The apparatus (1) according to claim 7, characterized in that the apparatus (1) has a container unit (15) with at least two levels (16, 17) so that the components (18) of the apparatus (1) are arranged on at least two levels (16, 17).

21. The apparatus (1) according to claim 7 characterized in that the apparatus (1) has a modular construction (20).

22. The apparatus (1) according to claim 21, characterized in that the apparatus (1) has a plurality of module places (19) at which the components (18) of the apparatus (1) can be mounted with an exact fit.

23-24. (canceled)

25. A forming plant (6) for forming semi-finished products, in particular a rolling mill (9), with a forming apparatus (5) for forming the semi-finished products and with an apparatus (1) for producing a cooling lubricant mixture (2), characterized by an apparatus (1) for producing a cooling lubricant mixture (2) comprising a preparation container for preparing operationally ready cooling lubricant mixture (2), with a base oil storage container (26), with a water storage container (28) and with a catch container (31) for the temporary collecting of used cooling lubricant mixture (2A), wherein the catch container (31) is actively connected to the preparation container (25) in such a manner that during the dwell time of the used cooling lubricant mixture (2A) flowing through the catch container (31) the thermal energy (44) in the used cooling lubricant mixture (2A) can be transferred at least partially to the operationally ready cooling lubricant mixture (2) present in the preparation container (25).
